(19) United States
(12) Patent Application Publication
(10) Pub. No.: US 2023/0300023 A1
(43) Pub. Date: Sep. 21, 2023

(54) CONTEXT-BASED COUPLINGS

(71) Applicant: HEWLETT-PACKARD DEVELOPMENT COMPANY, L.P., Spring, TX (US)

(72) Inventors: Janani ANAND, Spring, TX (US); Ravi Shankar SUBRAMANIAM, Palo Alto, CA (US); Peter Siyuan ZHANG, Spring, TX (US)

(21) Appl. No.: 17/697,666

(22) Filed: Mar. 17, 2022

(51) Int. Cl. H04L 41/0813; H04W 4/02; H04L 41/08

(52) U.S. Cl. CPC H04L 41/0813; H04W 4/023; H04L 41/0883

(57) ABSTRACT

In some examples an electronic device includes a sensor, and a controller to detect a proximity of a second electronic device via the sensor. In response to determining that the proximity is within a threshold distance, the controller causes transmission of context information to the second electronic device. The context information is generated based on a location, a time, an application executed by the second electronic device, or a combination thereof. In response to the transmission of the context information, the controller receives a first signal from the second electronic device, and, in response to the first signal, the controller causes transmission of a second signal, the second signal to enable coupling to the second electronic device.

### BACKGROUND

Couplings enable electronic devices to communicate with other electronic devices. The electronic devices include a desktop, laptop, notebook, tablet, smartphone, another suitable computing device, an input device (e.g., a keyboard, a mouse, a touchpad, an image sensor), an output device (e.g., a display device, a speaker, a light source), a network switch, a memory card, or other suitable electronic devices having controllers. The couplings may be via wired connections, wireless connections, or a combination thereof.

### BRIEF DESCRIPTION OF THE DRAWINGS

Various examples are described below referring to the following figures.

FIG. 1 is a block diagram of electronic devices having context-based couplings, in accordance with various examples.

FIG. 2 is a block diagram of electronic devices having context-based couplings, in accordance with various examples.

FIG. 3 is a block diagram of electronic devices having context-based couplings, in accordance with various examples.

FIG. 4 is a flow diagram of a method for an electronic device having context-based couplings, in accordance with various examples.

FIG. 5 is a block diagram of an electronic device having context-based couplings, in accordance with various examples.

FIG. 6 is a flow diagram of a method for an electronic device having context-based couplings, in accordance with various examples.

FIG. 7 is a block diagram of an electronic device having context-based couplings, in accordance with various examples.

FIG. 8 is a block diagram of an electronic device having context-based couplings, in accordance with various examples.

FIG. 9 is a block diagram of an electronic device having context-based couplings, in accordance with various examples.

FIG. 10 is a flow diagram of a method for an electronic device having context-based couplings, in accordance with various examples.

### DETAILED DESCRIPTION

As described above, couplings enable an electronic device to communicate with other electronic devices. A host device, as used herein, is an electronic device that directs operations of other electronic devices. A user uses the host device in numerous locations for a variety of tasks. Responsive to a change of location or a change of task within a location, the user adjusts coupling configurations of the host device. Adjusting the coupling configurations enables the host device to utilize different subsets of the other electronic devices based on the location, a day, a time, an application used to perform a task, a user of the host device, or a combination thereof. The application used to perform a task is herein referred to as an executing application. To adjust a coupling configuration, the user adjusts couplings from a first set of electronic devices to a second set of electronic devices. To adjust the coupling configuration, the user utilizes graphical user interfaces (GUIs) presented according to different executable codes. The different executable codes are associated with the different electronic devices, for instance. The GUIs are located in a variety of locations on the host device. Having various locations for adjusting the coupling configurations of electronic devices is confusing for the user and diminishes the user experience. Having the user adjust the coupling configurations delays a time during which the user performs tasks, resulting in user frustration.

To mitigate the user manually adjusting coupling configurations of host devices, some network protocols initiate couplings between the host device and the electronic devices to mitigate the user manually adjusting coupling configurations. However, such network protocols include unintended consequences or provide limited couplings. For instance, a network switch couples the host device to the electronic devices that are also coupled to the network switch but is unable to couple the host device to electronic devices that are not coupled to the network switch. Failing to couple an electronic device utilized for a specified application causes the user to manually adjust the coupling configuration. In another instance, the network switch couples the host device to electronic devices that are unnecessary for executing the specified application and fails to uncouple other electronic devices that are unnecessary for executing the specified application. Coupling the host device to, or not uncoupling the host device from, unused electronic devices unnecessarily utilizes resources of the host device.

This description describes an electronic device for context-based couplings. The electronic device may be a host device, a docking device, or other suitable electronic device including a communication device, a sensor, a controller, executable code to enable context-based couplings, or a combination thereof. A docking device, as used herein, is an electronic device that couples to a second electronic device and a third electronic device, thereby enabling coupling between the second electronic device and the third electronic device via a communication device of the docking device. The controller utilizes the sensor to detect proximity of the other electronic devices. Proximity, as used herein, indicates a distance between two objects is within a threshold distance. The threshold distance is a specified range of the sensor, for example. To detect proximity, the sensor detects a presence of the other electronic devices within a location shared with the electronic device. Location, as used herein, refers to an area determined by a detection range of the sensor. Utilizing a measurement of the sensor, the electronic device determines distances between the electronic device and the other electronic devices.

The controller determines context information for the electronic device. The context information, as used herein, refers to the location, conditions (e.g., lighting, noise) within the location, the day, the time, an executing application, the user of the electronic device, other information that identifies a specified task, or a combination thereof. The context information is stored in a coupling profile, in some examples. The coupling profile, as used herein, includes the context information, identifiers of electronic devices used under conditions of the context information, couplings for the electronic devices under the conditions of the context information, or a combination thereof. The electronic device stores multiple coupling profiles, in some examples. Based on the context information and the distances, the controller adjusts the couplings of the electronic device to the other electronic devices via the communication device. In some examples in which the controller is a controller of a host device, the controller adjusts the couplings to the other electronic devices by enabling or disabling settings for the other electronic devices within an operating system (OS) of the host device.

Utilizing the electronic device for context-based couplings enables the electronic device to couple to other electronic devices that are used for a specified task. The user experience is improved because the user does not have to adjust the couplings manually. Resources (e.g., battery, memory, processor usage) of the electronic device are not unnecessarily utilized because the electronic device does not couple to other electronic devices not used for the specified task.

In some examples in accordance with the present description, an electronic device is provided. The electronic device includes a sensor, and a controller to detect a proximity of a second electronic device via the sensor. In response to determining that the proximity is within a threshold distance, the controller causes transmission of context information to the second electronic device. The context information is generated based on a location, a time, an application executed by the second electronic device, or a combination thereof. In response to the transmission of the context information, the controller receives a first signal from the second electronic device, and in response to the first signal, the controller causes transmission of a second signal, the second signal to enable coupling to the second electronic device.

In other examples in accordance with the present description, an electronic device is provided. The electronic device includes a sensor, a communication device, and a controller. The controller detects multiple electronic devices via the sensor. In response to determining a first electronic device of the multiple electronic devices is a host device, the controller transmits a first signal via the communication device to the first electronic device of the multiple electronic devices. The first signal is to request context information for the first electronic device of the multiple electronic devices. The controller receives a second signal from the first electronic device of the multiple electronic devices via the communication device, the second signal including the context information, and based on the context information, enables coupling between the first electronic device of the multiple electronic devices and a subset of the multiple electronic devices via the communication device.

In some examples in accordance with the present description, a non-transitory machine-readable medium storing machine-readable instructions is provided. The term “non-transitory,” as used herein, does not encompass transitory propagating signals. The machine-readable instruction, when executed by a controller of an electronic device, causes the controller to determine a first measurement and a second measurement via a sensor. The first measurement is a first distance between a second electronic device and the electronic device, and the second measurement is a second distance between a third electronic device and the electronic device. In response to the first measurement and the second measurement being less than a threshold distance, the machine-readable instruction, when executed by the controller, causes the controller to determine context information of the electronic device. Based on the context information indicating a first context, the machine-readable instruction, when executed by the controller, causes the controller to enable coupling between the electronic device and the second electronic device, and based on the context information indicating a second context, the machine-readable instruction, when executed by the controller, causes the controller to enable coupling between the electronic device and the third electronic device.

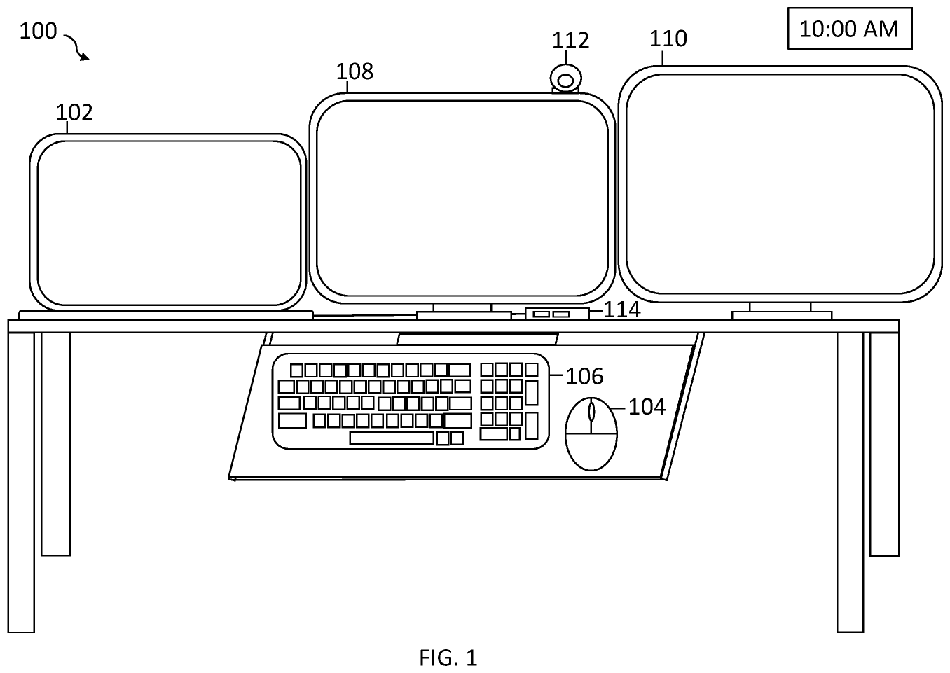

FIG. 1 is a block diagram of electronic devices 102, 104, 106, 108, 110, 112, 114 having context-based couplings, in accordance with various examples. The electronic devices 102, 104, 106, 108, 110, 112, 114 are disposed within a location 100. The location 100 is an office, a laboratory, or a classroom, for example. An electronic device 102 is a desktop, laptop, notebook, tablet, smartphone, or other suitable computing device, for example. The electronic device 102 is a host device, for example. Electronic devices 104, 106, 112 are input devices. An electronic device 104 is a mouse, for example. An electronic device 106 is a keyboard, for example. An electronic device 112 is an input sensor, for example. Electronic devices 108, 110 are display devices, for example. The electronic devices 108, 110 are liquid crystal displays (LCDs), light-emitting diode (LED) displays, plasma displays, quantum dot (QD) displays, or a combination thereof, for example. An electronic device 114 is a docking station, for example.

In various examples, the electronic device 102 is coupled to the electronic device 114 via a wired connection (e.g., a Universal Serial Bus (USB). The electronic device 114 is coupled to the electronic devices 108, 110 via a wired connection (e.g., USB, High-Definition Multimedia Interface (HDMI), Video Graphics Array (VGA), Digital Visual Interface (DVI), or other suitable display device connection) or via a wireless connection (e.g., BLUETOOTH®, Wi-Fi®, or other suitable wireless standard). The electronic device 114 is coupled to the electronic devices 104, 106, 112 via a wired connection (e.g., USB) or via a wireless connection (e.g., BLUETOOTH®, Wi-Fi®, or other suitable wireless standard). While the electronic device 102 is coupled to the electronic device 104, 106, 108, 110, 112 via the docking device 114, in other examples, the electronic device 102 is coupled to some of the electronic devices 104, 106, 108, 110, 112 via wired connections to ports of the electronic device 102 or via wireless connections.

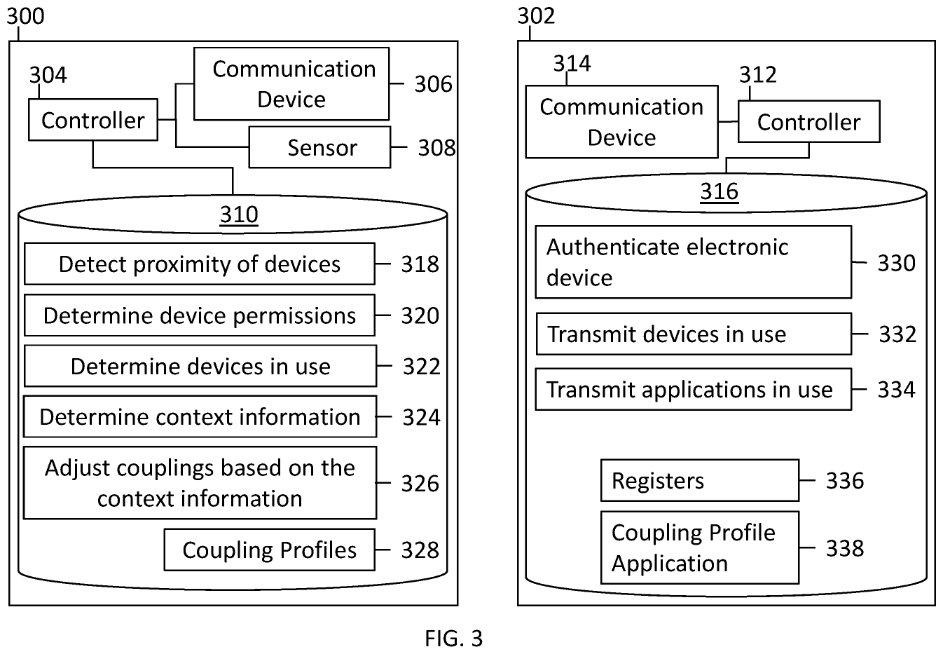

The electronic device 102, 104, 106, 108, 110, 112, 114 having context-based couplings include a communication device, a sensor, a controller, executable code to enable the context-based couplings, or a combination thereof, as shown below with respect to FIG. 3, 5, 7, or 8, for example. In some examples, a controller of a host device uses the sensor of the host device to detect proximity of the electronic devices 104, 106, 108, 110, 112, 114 to the electronic device 102. The controller detects proximity utilizing techniques described below with respect to FIG. 3, for example. Utilizing a measurement of the sensor of the host device, the host device determines distances between the electronic device 102 and the electronic devices 104, 106, 108, 110, 112, 114. The controller of the host device determines context information for the electronic device 102. The context information includes an identifier for the location 100 (e.g., “home office,” “office,” “classroom,” “lab station”), conditions within the location 100, the day, the time (e.g., 10:00 AM), an executing application, the user of the electronic device 102, other information that identifies a specified task, or a combination thereof. Based on the context information and the distances, the controller of the host device adjusts the couplings of the electronic device 102 to the other electronic devices 104, 106, 108, 110, 112, 114 via the communication device of the electronic device 102, by enabling or disabling settings for the electronic device 104, 106, 108, 110, 112, 114 within the operating system (OS) of the electronic device 102, or a combination thereof.

In other examples, a controller of the docking device uses the sensor of the electronic device 114 to detect proximity of the electronic devices 102, 104, 106, 108, 110, 112 to the electronic device 114. The controller detects proximity utilizing techniques described below with respect to FIG. 3, for example. Utilizing a measurement of the sensor of the docking device, the docking device determines distances between the electronic device 114 and the electronic devices 102, 104, 106, 108, 110, 112. The controller of the docking device determines context information for the electronic device 102. In some examples, the controller includes coupling profiles. In various examples, the controller includes coupling profiles for multiple host devices. To determine the context information for the electronic device 102, the controller compares an identifier of the electronic device 102 to identifiers of electronic devices within the coupling profiles. In other examples, to determine the context information for the electronic device 102, the controller transmits a signal via the communication device to request the context information from the electronic device 102. Based on the context information and the distances, the controller of the docking device adjusts the couplings of the electronic device 102 to the other electronic devices 104, 106, 108, 110, 112, via the communication device of the electronic device 114, by transmitting a signal to the electronic device 102 to enable or disable settings for the electronic device 104, 106, 108, 110, 112, within the operating system (OS) of the electronic device 102, or a combination thereof.

While the examples above describe the electronic device 102 or the electronic device 114 as adjusting couplings based on context information of the electronic device 102, in other examples, the electronic device 104, 106, 108, 110, 112 including a communication device, a sensor, a controller, executable code to enable the context-based couplings, or a combination thereof, adjusts the couplings based on the context information of the electronic device 102. In some examples, adjusting the couplings based on the context information of the electronic device 102 includes adjusting settings for the electronic device 102, 104, 106, 108, 110, 112, 114.

For example, during a first time window of a day, the user uses the electronic device 112 to capture images and a headset (not explicitly shown) having a first volume, has notifications for a first subset of applications enabled, and has reminders for a calendar application enabled. The controller determines that a second time window of the day begins. Utilizing a coupling profile associated with the second time window of the day and the location 100, the controller disables couplings between the electronic device 102 and the electronic device 112 and the headset. Utilizing the coupling profile associated with the second time window of the day and the location 100, the controller enables couplings between the electronic device 102 and an internal image sensor, an internal speaker having a second volume, and an internal microphone having a third volume of the electronic device 102 by adjusting settings of the OS of the electronic device 102. In examples in which the controller is not a component of the electronic device 102, the controller transmits a signal to the electronic device 102 via the communication device to adjust the settings of the OS of the electronic device 102. The signal includes the settings to be adjusted by the OS of the electronic device 102. Utilizing the coupling profile associated with the second time window of the day and the location 100, the controller disables the notifications for a number of the first subset of applications, enables notifications for a second subset of applications that is different than the first subset of applications, and disables reminders for the calendar application.

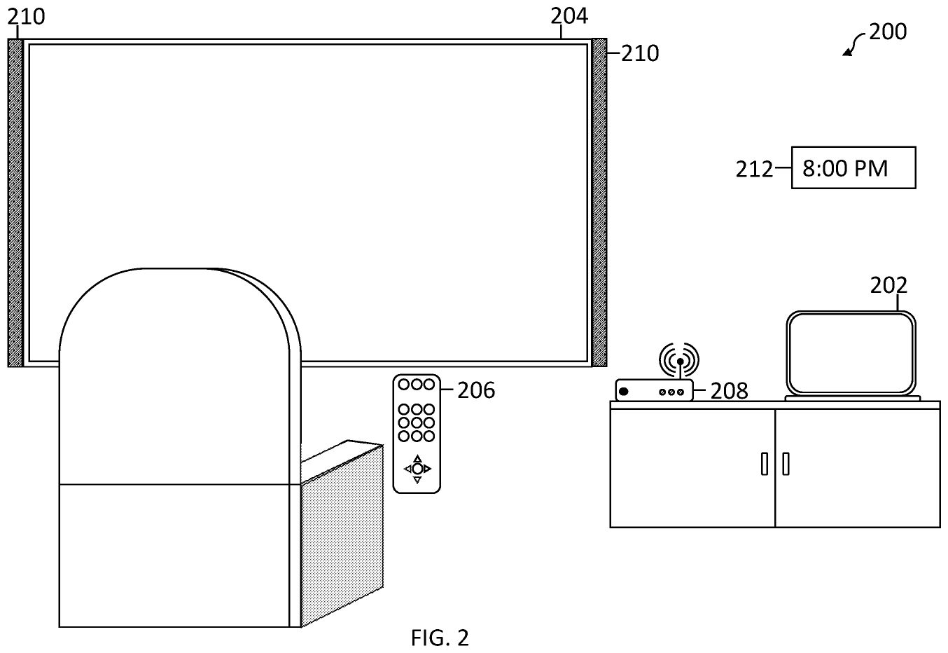

FIG. 2 is a block diagram of electronic devices 202, 204, 206, 208, 210, 212 having context-based couplings, in accordance with various examples. The electronic devices 202, 204, 206, 208, 210, 212 are disposed within a location 200. The location 200 is a living room or other room of a residential structure, for example. The electronic device 202 is the electronic device 102, for example. The electronic device 202 is a host device, for example. An electronic device 204 is a display device, for example. An electronic device 206 is a remote control device or a video streaming device, for example. The electronic device 206 is a docking device, for example. An electronic device 208 is a communication device. The electronic device 208 is a modem, a router, or a network switch, for example. Electronic devices 210 are speakers, for example. An electronic device 212 is a clock, for example.

As described above with respect to FIG. 1, the electronic device 202, 204, 206, 208, 210, 212 having context-based couplings include a communication device, a sensor, a controller, executable code to enable the context-based couplings, or a combination thereof. In some examples, adjusting the couplings based on the context information of the electronic device 202 includes adjusting settings for the electronic device 202, 204, 206, 208, 210, 212. For example, at a first time of a day, the user enters the location 200 with the electronic device 202. In response to detecting the presence of the electronic device 202, the electronic device 206 transmits a signal to the electronic device 202 to disable an internal image sensor and internal speakers of the electronic device 202 in accordance with a first coupling profile for the electronic device 202.

In various examples, in response to a specified period of time elapsing without receiving notifications on the electronic device 202, the electronic device 206 determines context information for the electronic device 202 has adjusted from a work time to a personal time. In response to the determination, the electronic device 206 transmits a signal to the electronic device 202 to disable notifications and unused applications of the electronic device 206, and enables couplings between the electronic device 202 and the electronic device 204, 210, 212. In response to the context information indicating the personal time, the electronic device 202 transmits a signal to the electronic device 212 to dim a light source of the clock, transmits a signal to switch on the electronic device 204, and transmits a signal to the electronic device 210 to adjust a volume of the speakers.

FIG. 3 is a block diagram of electronic devices 300, 302 having context-based couplings, in accordance with various examples. The electronic device 300 is a docking device, for example. The electronic device 302 is a host device, for example. The electronic device 300 includes a controller 304, a communication device 306, a sensor 308, and a storage device 310. The communication device 306 is a wireless transceiver or other suitable device that enables wireless communication (e.g., BLUETOOTH®, Wi-Fi®). The electronic device 302 includes a controller 312, a communication device 314, and a storage device 316.

In various examples, the controller 304, 312 is a microcontroller, a microcomputer, a programmable integrated circuit, a programmable gate array, or other suitable device for managing operations of the electronic device 300, 302, respectively, or a component or multiple components of the electronic device 300, 302, respectively. For example, the controller 304, 312 is a central processing unit (CPU), a graphics processing unit (GPU), or an embedded security controller (EpSC). In another example, the controller 304, 312 is embedded on an artificial intelligence (AI) chip. In some examples, the AI chip includes the communication device 306, 314, the sensor 308, the controller 304, 312, the storage device 310, 316 storing the executable code, which, when executed by the controller 304, 312 causes the controller 304, 312 to enable context-based couplings, or a combination thereof.

The communication device 306, 314 operates according to a wireless communication standard or specification, in some examples. The wireless communication standard or specification is the Institute of Electrical and Electronics Engineers (IEEE) 802.11 standard or other suitable standard for communication in frequency bands designated by governmental standards or specifications for wireless communication. The sensor 308 is an infrared (IR) sensor, a proximity sensor, an ultrasonic sensor, or other suitable sensor for detecting a presence of another electronic device. The storage device 310, 316 is a hard drive, a solid-state drive (SSD), flash memory, random access memory (RAM), or other suitable memory for storing data or machine-readable instructions of the electronic device 300, 302, respectively.

While not explicitly shown, in some examples, the electronic device 300, 302 includes video adapters, sound cards, local buses, peripheral devices (e.g., a keyboard, a mouse, a touchpad, a speaker, a microphone, a display device), or a combination thereof. In various examples, the controller 304 is coupled to the communication device 306, the sensor 308, and the storage device 310. The controller 312 is coupled to the communication device 314 and the storage device 316.

The storage device 310 stores machine-readable instructions 318, 320, 322, 324, 326, which, when executed by the controller 304, cause the controller 304 to perform, in some examples, some or all of the actions attributed herein to the controller 304. In various examples, the storage device 310 stores coupling profiles 328. The machine-readable instructions 318, 320, 322, 324, 326, when executed by the controller 304, cause the controller 304 to enable context-based couplings. The machine-readable instruction 318, when executed by the controller 304, causes the controller 304 to detect a proximity between the electronic devices 300, 302. The machine-readable instruction 320, when executed by the controller 304, causes the controller 304 to determine whether the electronic device 300 has permission to couple to the electronic device 302. The machine-readable instruction 322, when executed by the controller 304, causes the controller 304 to determine other electronic devices (not explicitly shown) in use by the electronic device 302. The machine-readable instruction 324, when executed by the controller 304, causes the controller 304 to determine context information for the electronic device 302. Based on the context information, the machine-readable instruction 326, when executed by the controller 304, causes the controller 304 to adjust couplings between the electronic device 302 and the other electronic devices (not explicitly shown).

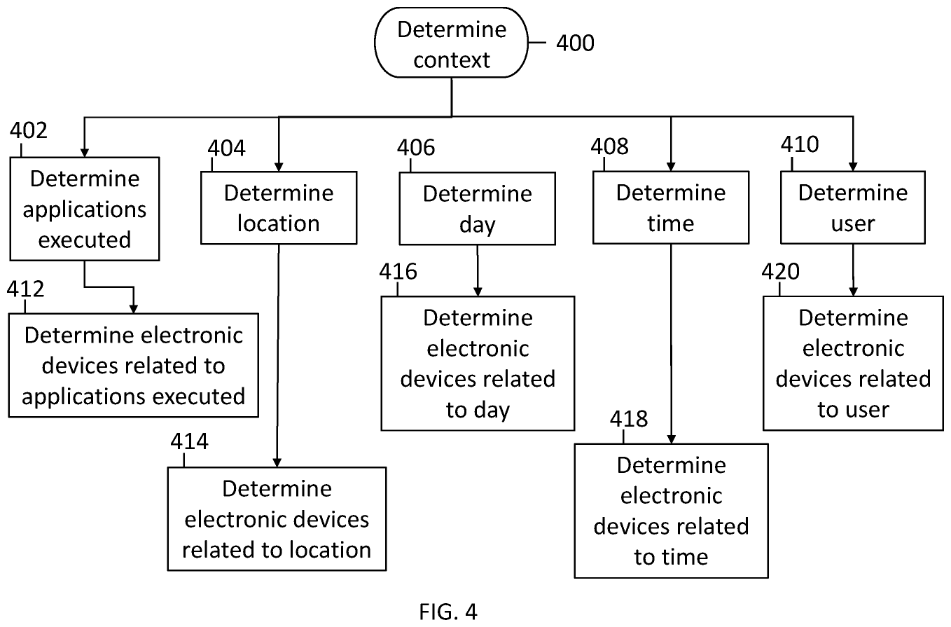

The storage device 316 stores machine-readable instructions 330, 332, 334, which, when executed by the controller 312, cause the controller 312 to perform, in some examples, some or all of the actions attributed herein to the controller 312. The storage device 316 stores registers 336 and a coupling profile application 338. The registers 336 indicate resources (e.g., identifiers of other electronic devices, identifiers of executing applications) of the electronic device 302 that are in use. The coupling profile application 338 is a GUI that enables a user to specify coupling profiles 328, for example. The coupling profile application 338 is implemented using executable code, for example. In some examples, the user specifies information for multiple coupling profiles, as described below with respect to FIG. 4.

The machine-readable instructions 330, 332, 334, when executed by the controller 312, cause the controller 312 to enable context-based couplings. The machine-readable instruction 330, when executed by the controller 312, causes the controller 312 to authenticate the electronic device 300. The machine-readable instruction 332, when executed by the controller 312, causes the controller 312 to transmit identifiers for executing applications of the electronic device 302. The machine-readable instruction 334, when executed by the controller 312, causes the controller 312 to transmit identifiers of other electronic devices in use by the electronic device 302.

In various examples, the controller 304 detects proximity of the electronic device 300 to the electronic device 302 via the sensor 308. As described above, the proximity indicates that a distance between two objects is within a threshold distance. In some examples, the threshold distance is equivalent to the detection range of the sensor 308. In other examples, the threshold distance is less than the detection range of the sensor 308. A threshold distance that is less than the detection range of the sensor 308 decreases a connection time between electronic devices 300, 302, increases a bandwidth over which communications between the electronic device 300, 302, or a combination thereof.

In some examples, to detect the proximity of the electronic device 302, the sensor 308 emits an electromagnetic (EM) field. In response to a metal object entering the EM field, the sensor 308 detects the electronic device 302 is disposed within a location (e.g., the location 100, 200) that includes the electronic device 300. In another example, the sensor 308 emits a signal. The sensor 308 determines a reflection time that includes a travel time for the signal to travel from the sensor 308 to an object and a travel time for the signal to reflect back from the object to the sensor 308. In response to a determination that the reflection time is less than a threshold time, the electronic device 300 determines that the electronic device 302 is within proximity of the electronic device 300. The threshold time is based on the threshold distance.

In other examples, to detect the proximity of the electronic device 302, the communication device 306 detects a signal. The signal is a low energy signal of a beacon for a personal area network, for example. The controller 304 determines a distance based on a strength of signal.

In some examples, in response to determining that the electronic device 302 is disposed within the location that includes the electronic device 300, the controller 304 determines coupling permissions of the electronic device 302 utilizing the coupling profiles 328. For example, the controller 304 transmits a signal via the communication device 306 to request an identifier of the electronic device 302. In some examples, in response to receiving the signal requesting the identifier via the communication device 314, the controller 312 authenticates an identifier of the signal received. Authenticating that the identifier of the signal received is an identifier of the electronic device 300 indicates a secure relationship for transmissions between the electronic devices 300, 302. In response to authenticating the identifier of the signal received, the controller 312 transmits a signal that includes the identifier of the electronic device 302 via the communication device 314. In response to receiving the identifier of the electronic device 302 via the communication device 306, the controller 304 determines coupling permissions of the electronic device 302 by comparing the identifier to identifiers within the coupling profiles 328. In response to a comparison indicating that the identifier is equivalent to an identifier within the coupling profiles 328, the controller 304 enables coupling with the electronic device 302. In various examples, the controller 304 enables coupling between other electronic devices (not explicitly shown) that are coupled to the electronic device 300 and the electronic device 302 via the communication device 306.

In some examples, the controller 304 determines other electronic devices in use by the electronic device 302 by transmitting a signal via the communication device 306. In response to receiving the signal via the communication device 314, the controller 312 transmits a signal that includes identifiers of other electronic devices in use by the electronic device 302. In various examples, the controller 304 determines the context information by determining a location, determining a day, determining a time, determining applications in use by the electronic device 302, or a combination thereof, utilizing the techniques described below with respect to FIG. 4. In some examples, to determine the applications in use by the electronic device 302, the controller 304 transmits a signal via the communication device 306. In response to receiving the signal via the communication device 314, the controller 312 transmits a signal that includes identifiers of executing applications of the electronic device 302.

In various examples, the controller 304 compares the other electronic devices in use by the electronic device 302, the executing applications, or a combination thereof, to the coupling profiles 328 utilizing the identifier of the electronic device 302. For example, the coupling profiles 328 include first and second coupling profiles that include the identifier. The controller 304 compares a current time to a first time window of the first coupling profile and a second time window of the second coupling profile. In response to the current time being within the first time window, the controller 304 utilizes the first coupling profile to compare the other electronic devices in use by the electronic device 302, the executing applications, or a combination thereof, during the first time window. In response to the current time being within the second time window, the controller 304 utilizes the second coupling profile to compare the other electronic devices in use by the electronic device 302, the executing applications, or a combination thereof, during the second time window.

In some examples, in response to the comparison indicating that the other electronic devices in use by the electronic device 302 include some electronic devices that are not utilized in the context that is indicated by a coupling profile that is associated with the current time, the controller 304 disables the electronic devices that are not utilized. In other examples, in response to the comparison indicating that the other electronic devices in use by the electronic device 302 do not include an additional electronic device that is utilized in the context that is indicated by the coupling profile that is associated with the current time, the controller 304 determines whether the additional electronic device is disposed within the location. In response to a determination that the additional electronic device is disposed within the location, the controller 304 enables coupling between the electronic device 302 and the additional electronic device.

Utilizing the electronic device 300 for context-based couplings enables the electronic device 302 to couple to other electronic devices appropriate for a specified task based on the executing application, the location, the day, the time, the user, or other suitable context information. The user experience is improved because the user does not have to adjust the couplings manually. Resources of the electronic device 302 are not unnecessarily utilized because the electronic device 300 does not enable the electronic device 302 to couple to other electronic devices not used for the specified task.

Referring now to FIG. 4, a flow diagram of a method 400 for an electronic device (e.g., the electronic device 102, 104, 106, 108, 110, 112, 114, 202, 204, 206, 208, 210, 212, 300, 302) to perform context-based couplings is shown, in accordance with various examples. The method 400 is a method for determining context information, for example. The method 400 includes determining applications executed (402). The method 400 also includes determining a location (404). The method 400 includes determining a day (406). Additionally, the method 400 includes determining a current time (408). The method 400 also includes determining a user (410). The method 400 includes determining electronic devices related to the applications executed (412). The method 400 also includes determining electronic devices related to the location (414). The method 400 includes determining electronic devices related to the day (416). Additionally, the method 400 includes determining electronic devices related to the time (418). The method 400 also includes determining electronic devices related to the user (420).

The method 400 includes determining applications executed utilizing techniques described above with respect to FIG. 3, for example. To determine the electronic devices related to the applications, the method 400 includes transmitting a signal to a target electronic device to determine devices in use, for example. The target electronic device is a host device, for example.

In various examples, the method 400 includes determining the location utilizing location determination logic. The location determination circuitry includes a Global Positioning System (GPS), a wireless transceiver (e.g., the communication device 306), executable code, or a combination thereof. The method 400 includes determining a coordinate via the location determination circuitry. The method 400 also includes determining a detection radius of a sensor (e.g., the sensor 308) utilized for enabling context-based couplings. Additionally, the method 400 includes determining the location (e.g., the location 100, 200) by determining an area described by a circle having the coordinate as a center and a radius that is equivalent to the detection radius of the sensor.

In some examples, the method 400 includes determining the day, the time, or the combination thereof, utilizing a system clock of the electronic device. In other examples, the method 400 includes the electronic device determining the day, the time, or the combination thereof, by transmitting a signal that requests the day, the time, or the combination thereof, from a target electronic device.

In various examples, the method 400 includes determining whether an electronic device having context-based couplings has multiple users. In response to a determination that the electronic device has multiple users, the method 400 includes determining a user identifier for a user of the multiple users. The method 400 includes determining the user identifier by transmitting a signal that requests the user identifier from the target electronic device. Additionally, the method 400 includes utilizing the user identifier to determine whether the user is associated with specific electronic devices.

In some examples, the method 400 is performed by the electronic device utilizing a machine learning technique. For example, the method 400 includes the electronic device utilizing the machine learning technique collects data on locations that the electronic device is within, the applications executed within the locations, the days the electronic device is within the locations, the times the electronic device is within the locations, the other electronic devices that the electronic device couples to within the locations, or a combination thereof. The method 400 also includes the electronic device analyzing the data to determine patterns of usage of the other electronic devices based on applications executed, locations, days, times, users, or a combination thereof. In various examples, the method 400 includes generating coupling profiles based on the analysis. In some examples, the method 400 includes prompting a user to verify the generated coupling profiles. The user verifies the coupling profiles utilizing a coupling profile application (e.g., the coupling profile application 338), for example.

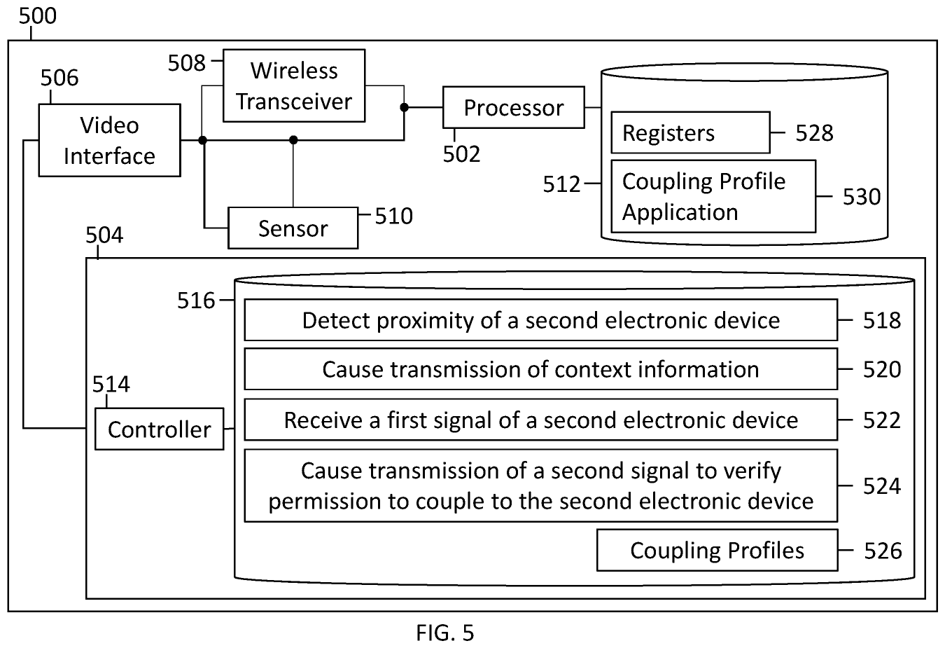

FIG. 5 is a block diagram of an electronic device 500 having context-based couplings, in accordance with various examples. The electronic device 500 is the electronic device 302 including the electronic device 300, for example. The electronic device 500 includes a processor 502, an AI chip 504, a video interface 506, a wireless transceiver 508, a sensor 510, and a storage device 512. The processor 502 is the controller 312, for example. The processor 502 is a CPU, GPU, or EpSC, for example. The AI chip 504 includes a controller 514 and a storage device 516. The controller 514 is the controller 304, for example. The storage device 516 is the storage device 310, for example. The video interface 506 is a USB interface, an HDMI, a VGA interface, a DVI, or other suitable interface for coupling a display device to the electronic device 500, for example. The wireless transceiver 508 is the communication device 306, 314, for example. The sensor 510 is the sensor 308, for example. The storage device 512 is the storage device 316, for example.

In various examples, the processor 502 is coupled to the AI chip 504 via the video interface 506, the wireless transceiver 508, the sensor 510, and the storage device 512. The controller 514 is coupled to the storage device 516.

In some examples, the storage device 512 stores registers 528 and coupling profile application 530. The registers 528 are the registers 336, for example. The coupling profile application 530 is the coupling profile application 338. While the storage device 516 is shown storing coupling profiles 526, in some examples, the storage device 512 stores the coupling profiles 526. The coupling profiles 526 are the coupling profiles 328, for example.

The storage device 516 stores machine-readable instructions 518, 520, 522, 524, which, when executed by the controller 514, cause the controller 514 to perform, in various examples, some or all of the actions attributed herein to the controller 514. The machine-readable instructions 518, 520, 522, 524, when executed by the controller 514, cause the controller 514 to enable context-based couplings. The machine-readable instruction 518, when executed by the controller 514, causes the controller 514 to detect a proximity of a second electronic device. The machine-readable instruction 520, when executed by the controller 514, causes the controller 514 to cause transmission of context information. The machine-readable instruction 522, when executed by the controller 514, causes the controller 514 to receive a first signal of a second electronic device. The machine-readable instruction 524, when executed by the controller 514, causes the controller 514 to cause transmission of a second signal to verify permission to couple to the second electronic device.

In some examples, the controller 514 detects the proximity of the second electronic device via the sensor 510. The controller 514 detects the proximity utilizing the techniques described above with respect to FIG. 3, for example. In response to determining that the proximity is within a threshold distance, the controller 514 causes transmission of the context information via the wireless transceiver 508 to the second electronic device. In response to the transmission of the context information, the controller 514 receives a first signal from the second electronic device, and in response to the first signal, the controller 514 causes transmission of a second signal, the second signal to enable coupling to the second electronic device.

In various examples, in response to the first signal, the controller 514 causes transmission of a third signal via the wireless transceiver 508. The third signal enables coupling to a third electronic device via the second electronic device. In some examples, the controller 514 detects a proximity of the third electronic device via the sensor 510 and causes transmission of a third signal via the wireless transceiver 508 to the third electronic device. The third signal is to initiate an authentication protocol with the third electronic device.

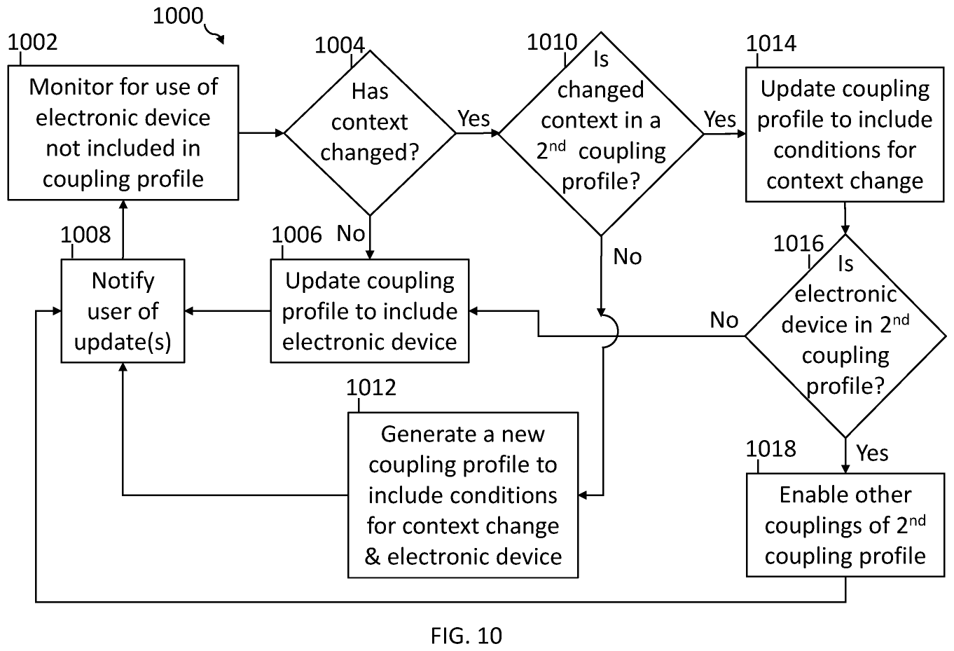

In some examples, the controller 514 generates the context information based on an application executed, a user identifier, an identifier of a third electronic device coupled to the electronic device 500, or a combination thereof. The controller 514 determines the application executed utilizing the registers 528, for example. The controller 514 generates the context information utilizing the techniques described above with respect to FIG. 4 or described below with respect to FIG. 10, for example. In various examples, the controller 514 stores the context information to a coupling profile of the coupling profiles 526. The coupling profile includes an identifier of the second electronic device, the identifier of the third electronic device, the user identifier, an identifier of the application executed, the location, the day, the time, or the combination thereof. In various examples, the controller 514 prompts the user to verify the coupling profiles 526 via a GUI of the coupling profile application 530.

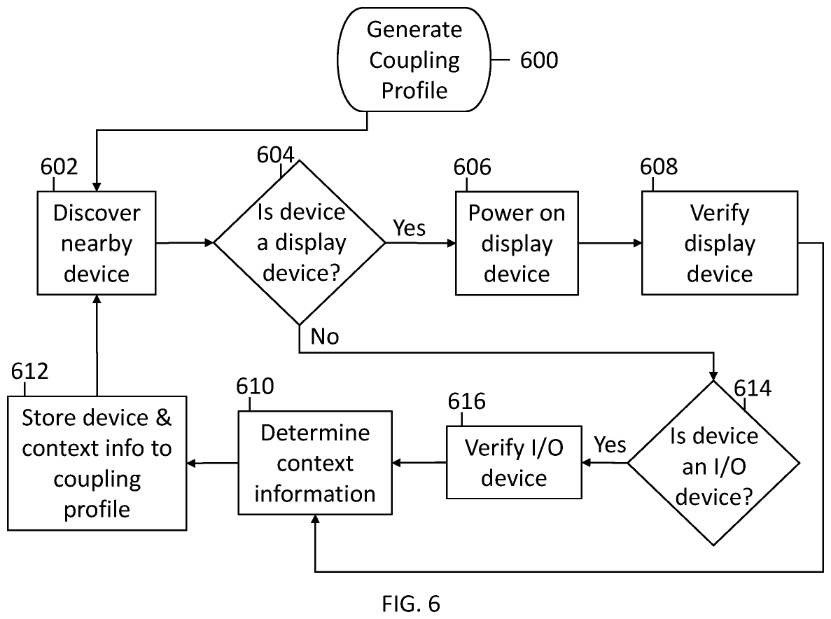

FIG. 6 is a flow diagram of a method 600 for an electronic device (e.g., the electronic device 102, 104, 106, 108, 110, 202, 204, 206, 208, 300, 302) having context-based couplings, in accordance with various examples. The method 600 is a method for generating a coupling profile. The method 600 includes discovering a nearby electronic device (602). The method 600 also includes determining whether the electronic device is a display device (604). In response to a determination that the electronic device is a display device, the method 600 additionally includes powering on a display device (606). The method 600 includes verifying the display device (608).

In response to a determination that the electronic device is not a display device, the method 600 includes determining whether the electronic device is an input/output (I/O) device (614). In response to a determination that the electronic device is an I/O device, the method additionally includes verifying the I/O device (616). The method 600 also includes determining context information (610). The method 600 includes storing information for the electronic device and the context to a coupling profile (612). The method 600 also includes returning to discovering a nearby electronic device via the sensor.

In various examples, the method 600 includes discovering a nearby electronic device via a sensor. The method 600 includes using the sensor to detect a proximity of the electronic device utilizing the techniques described above with respect to FIG. 3, for example. In other examples, the method 600 includes discovering a nearby electronic device via a signal received from the nearby electronic device. For example, a user enters an identifying sequence utilizing an I/O device. The I/O device transmits a signal that includes the identifying sequence. The method 600 includes discovering the I/O device by receiving the signal. The identifying sequence, as used herein, is a sequence of clicks, keystrokes, gestures, or other suitable specified input for an I/O device.

In some examples, the method 600 includes determining whether the electronic device is a display device or an I/O device by causing transmission of a signal to the electronic device, the signal to request an identifier of the electronic device. In response to receiving a signal that includes Extended Display Identification Data (EDID), the method 600 includes determining that the electronic device is a display device, for example. In another example, in response to receiving the signal that includes an identifying sequence, the method 600 includes determining that the electronic device is an I/O device. In various examples, the method 600 includes determining a type of the I/O device based on the identifying sequence. For example, in response to the identifying sequence being a sequence of keystrokes, the method 600 includes determining that the I/O device is a keyboard. In another example, in response to the identifying sequence being a sequence of clicks, the method 600 includes determining that the I/O device is a mouse. In another example, in response to the identifying sequence being a sequence of gestures, the method 600 includes determining that the I/O device is an image sensor. The sequence of gestures is a gesture performed for a specified time period, in some examples. In other examples, the sequence of gestures is a series of sequential gestures.

In some examples, to verify the electronic device is a display device, the method 600 includes causing transmission of a signal for display by the display device. The method 600 also includes causing a second display device of a host device to display a prompt prompting the user to verify that the display device is displaying data of the signal. In other examples, to verify the electronic device is an I/O device, the method 600 includes causing a display device of a host device to display a prompt prompting the user to enter an identifying sequence. The method 600 also includes receiving a signal from the I/O device, the signal including a received sequence. In response to the received sequence being equivalent to the identifying sequence, the method 600 includes verifying that the electronic device is the I/O device. In various examples, the method 600 includes determining the context information utilizing the techniques described above with respect to FIGS. 4, 10.

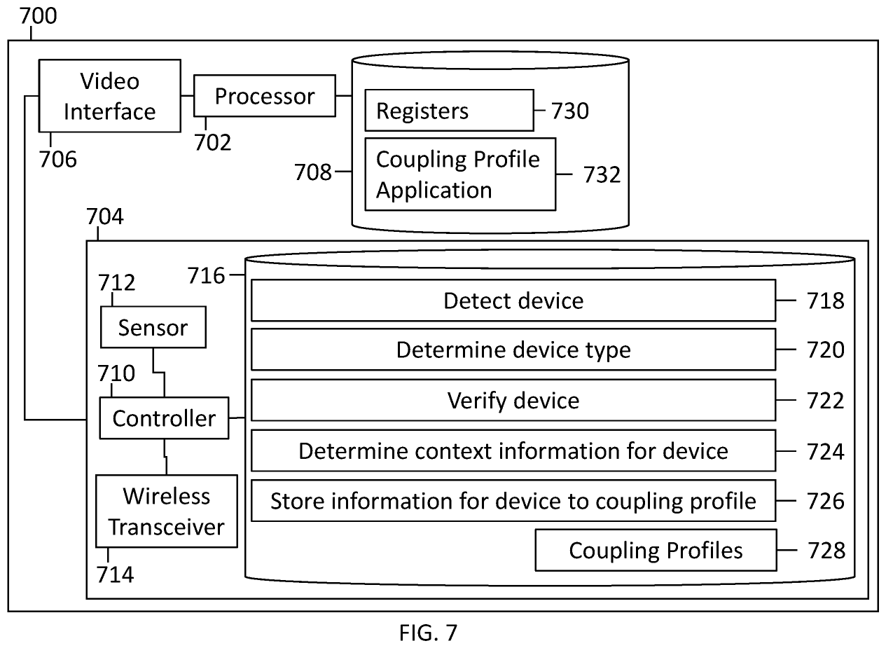

FIG. 7 is a block diagram of an electronic device 700 having context-based couplings, in accordance with various examples. The electronic device 700 is the electronic device 500, for example. The electronic device 700 includes a processor 702, an AI chip 704, a video interface 706, and a storage device 708. The processor 702 is the processor 502, for example. The video interface 706 is the video interface 506, for example. The AI chip 704 includes a controller 710, a sensor 712, a wireless transceiver 714, and a storage device 716. The controller 710 is the controller 514, for example. The sensor 712 is the sensor 510, for example. The wireless transceiver 714 is the wireless transceiver 508, for example. The storage device 716 is the storage device 516, for example.

In various examples, the processor 702 is coupled to the AI chip 704 via the video interface 706 and the storage device 708. The controller 710 is coupled to the sensor 712, the wireless transceiver 714, and the storage device 716.

The storage device 716 stores machine-readable instructions 718, 720, 722, 724, 726, which, when executed by the controller 710, cause the controller 710 to perform, in some examples, some or all of the actions attributed herein to the controller 710. The machine-readable instructions 718, 720, 722, 724, 726, when executed by the controller 710, cause the controller 710 to generate coupling profiles 728 for enabling context-based couplings. The machine-readable instructions 720, 722, 724, 726, when executed by the controller 710, cause the controller 710 to perform the method 600, for example.

In various examples, the machine-readable instruction 718, when executed by the controller 710, causes the controller 710 to detect an electronic device. The machine-readable instruction 720, when executed by the controller 710, causes the controller 710 to determine a type of the electronic device. The machine-readable instruction 722, when executed by the controller 710, causes the controller 710 to verify the electronic device. The machine-readable instruction 724, when executed by the controller 710, causes the controller 710 to determine context information for the electronic device. The controller 710 uses techniques described above with respect to FIG. 4 or below with respect to FIG. 10 to determine the context information, for example. The machine-readable instruction 726 stores information related to the electronic device and the context to the coupling profiles 728.

The storage device 708 stores registers 730 and coupling profile application 732. The registers 730 are the registers 528, for example. The coupling profile application 732 is the coupling profile application 530, for example. While coupling profiles 728 are shown stored to the storage device 716, in some examples, the storage device 708 stores the coupling profiles 728. The coupling profiles 728 are the coupling profiles 526, for example. In various examples, the machine-readable instructions of the coupling profile application 732, when executed by the processor 702, cause the processor 702 to determine that information has been stored to the coupling profiles 728. In response to the determination that information has been stored to the coupling profiles 728, the machine-readable instructions of the coupling profile application 732, when executed by the processor 702, cause the processor 702 to cause a display device (not explicitly shown) to display a prompt that prompts the user to verify the information stored to the coupling profiles 728.

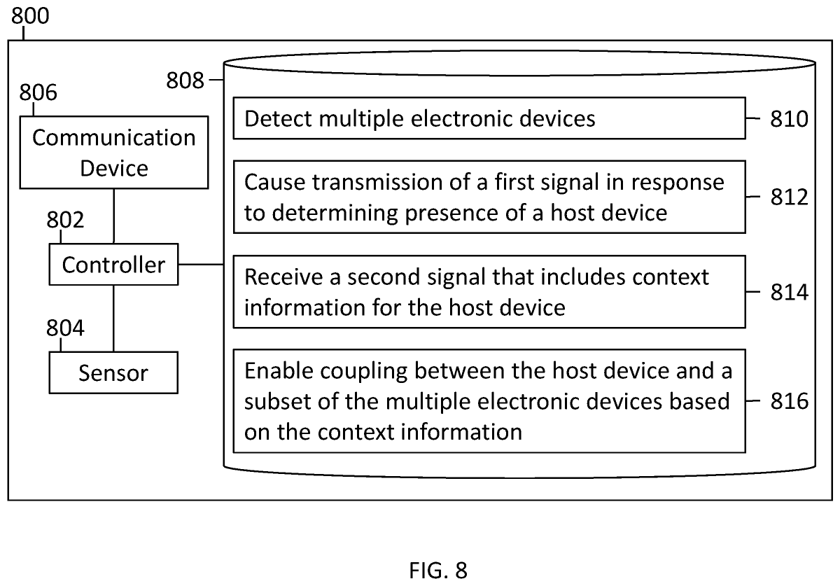

FIG. 8 is a block diagram of an electronic device 800 having context-based couplings, in accordance with various examples. The electronic device 800 is the electronic device 104, 106, 108, 110, 112, 114, 204, 206, 208, 210, 212, 300, 700, for example. The electronic device 800 includes a controller 802, a sensor 804, a communication device 806, and a storage device 808. The controller 802 is the controller 304, 710, for example. The sensor 804 is the sensor 308, 712, for example. The communication device 806 is the communication device 306 or the wireless transceiver 714, for example. The storage device 808 is the storage device 310, 716, for example.

In various examples, the controller 802 is coupled to the sensor 804, the communication device 806, and the storage device 808. The storage device 808 stores machine-readable instructions 810, 812, 814, 816, which, when executed by the controller 802, cause the controller 802 to perform, in some examples, some or all of the actions attributed herein to the controller 802. The machine-readable instructions 810, 812, 814, 816, when executed by the controller 802, cause the controller 802 to enable context-based couplings.

In various examples, the machine-readable instruction 810, when executed by the controller 802, causes the controller 802 to detect multiple electronic devices. The machine-readable instruction 812, when executed by the controller 802, causes the controller 802 to cause transmission of a first signal in response to determining a presence of a host device. The machine-readable instruction 814, when executed by the controller 802, causes the controller 802 to receive a second signal that includes context information for the host device. The machine-readable instruction 816, when executed by the controller 802, causes the controller 802 to enable coupling between the host device and a subset of the multiple electronic devices based on the context information.

In some examples, the controller 802 detects the multiple electronic devices via the sensor 804. The controller 802 detects the multiple electronic devices via the sensor 804 utilizing the techniques as described above with respect to FIG. 3, for example. In response to determining a first electronic device of the multiple electronic devices is a host device (e.g., the electronic device 102, 202, 302, 500), the controller 802 transmits a first signal via the communication device 806 to the first electronic device of the multiple electronic devices. The first signal requests context information for the first electronic device of the multiple electronic devices. The controller 802 receives a second signal from the first electronic device of the multiple electronic devices via the communication device 806. The second signal includes the context information. Based on the context information, the controller 802 enables coupling between the first electronic device of the multiple electronic devices and a subset of the multiple electronic devices via the communication device 806.

In various examples, the controller 802 compares the context information to coupling profiles to determine the subset of the multiple electronic devices. The coupling profiles are stored to the storage device 808, for example. In some examples, the controller 802 determines a time and an identifier of the first electronic device of the multiple electronic devices indicates a second context information. The controller 802 compares the second context information to the coupling profiles to determine a second subset of the multiple electronic devices associated with the second context information. The controller 802 enables coupling between the first electronic device of the multiple electronic devices and the second subset of the multiple electronic devices.

In some examples, in response to the second subset of the multiple electronic devices not including the electronic devices of the first subset of the multiple electronic devices, the controller 802 disables coupling between the first electronic device of the multiple electronic devices and the first subset of the multiple electronic devices. In other examples, the first subset and the second subset of the multiple electronic devices include a second electronic device of the multiple electronic devices. The controller 802 disables coupling between the first electronic device and a third subset of the first subset of the multiple electronic devices that does not include the second electronic device. The controller 802 enables coupling between the first electronic device and a fourth subset of the second subset of the multiple electronic devices that does not include the second electronic device.

In various examples, the controller 802 receives a third signal from the first electronic device of the multiple electronic devices via the communication device 806. The third signal includes a second context information. Based on the second context information, the controller 802 enables coupling between the first electronic device of the multiple electronic devices and a second subset of the multiple electronic devices via the communication device 806. In some examples, the second subset of the multiple electronic devices is different from the first subset of the multiple electronic devices.

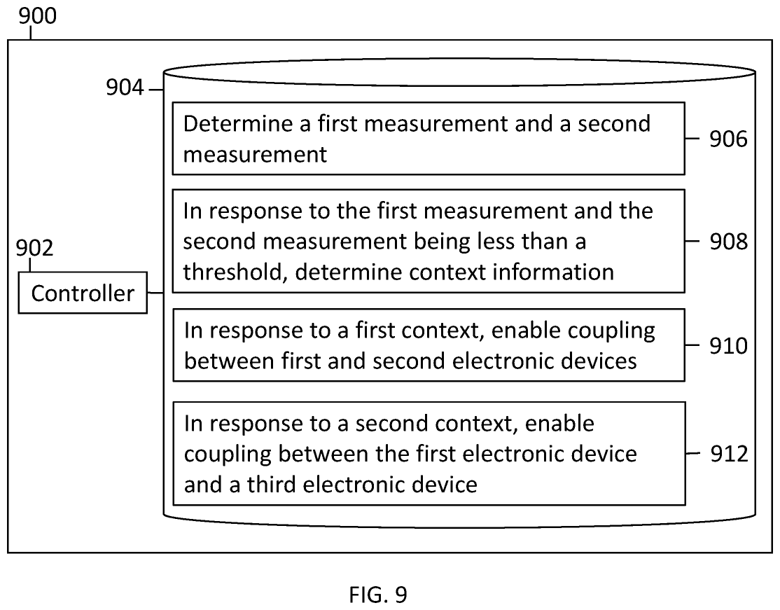

FIG. 9 is a block diagram of an electronic device 900 having context-based couplings, in accordance with various examples. The electronic device 900 is the electronic device 104, 106, 108, 110, 204, 206, 208, 300, 700, 800, for example. The electronic device 900 includes a controller 902 and a non-transitory machine-readable medium 904. The controller 902 is the controller 304, 710, 802, for example. The non-transitory machine-readable medium 904 is the storage device 310, 716, 808, for example.

In some examples, the controller 902 is coupled to the non-transitory machine-readable medium 904. In various examples, the non-transitory machine-readable medium 904 stores machine-readable instructions, which, when executed by the controller 902, cause the controller 902 to perform some or all of the actions attributed herein to the controller 902. The machine-readable instructions are the machine-readable instructions 906, 908, 910, 912.

In various examples, the machine-readable instructions 906, 908, 910, 912, when executed by the controller 902, cause the controller 902 to enable context-based couplings. The machine-readable instruction 906, when executed by the controller 902, causes the controller 902 to determine a first measurement and a second measurement. In response to the first measurement and the second measurement being less than a threshold, the machine-readable instruction 908, when executed by the controller 902, causes the controller 902 to determine context information. In response to a first context, the machine-readable instruction 910, when executed by the controller 902, causes the controller 902 to enable coupling between a first electronic device and a second electronic device. In response to a second context, the machine-readable instruction 912, when executed by the controller 902, causes the controller 902 to enable coupling between the first electronic device and a third electronic device.

In some examples, the machine-readable instructions 906, 908, 910, 912, when executed by the controller 902, cause the controller 902 to determine a first measurement and a second measurement via a sensor (e.g., the sensor 308, 510, 712). The controller 902 determines the first and the second measurements via the sensor utilizing the techniques described above with respect to FIG. 3, for example. The first measurement is a first distance between a second electronic device and the electronic device 900. The second measurement is a second distance between a third electronic device and the electronic device 900. In response to the first measurement and the second measurement being less than a threshold distance, the machine-readable instructions, when executed by the controller 902, cause the controller 902 to determine context information of the electronic device 900. The controller 902 uses techniques described above with respect to FIG. 4 to determine the context information, for example. Based on the context information indicating a first context, the machine-readable instructions, when executed by the controller 902, cause the controller 902 to enable coupling between the electronic device 900 and the second electronic device, and based on the context information indicating a second context, the machine-readable instructions, when executed by the controller 902, cause the controller 902 to enable coupling between the electronic device 900 and the third electronic device.

In various examples, the machine-readable instructions, when executed by the controller 902, cause the controller 902 to determine a third measurement via the sensor. The third measurement is a second distance between the second electronic device and the electronic device 900. In response to the third measurement being greater than the threshold distance, the machine-readable instructions, when executed by the controller 902, cause the controller 902 to disable coupling between the electronic device 900 and the second electronic device.

In other examples, the machine-readable instructions, when executed by the controller 902, cause the controller 902 to, based on the context information indicating a third context, enable coupling between the second electronic device and the third electronic device. In some examples, the machine-readable instructions, when executed by the controller 902, cause the controller 902 to determine a third measurement and a fourth measurement via the sensor. The third measurement is a second distance between the second electronic device and the electronic device 900, and the fourth measurement is a second distance between the third electronic device and the electronic device 900. In response to the third measurement or the fourth measurement being greater than the threshold distance, the machine-readable instructions, when executed by the controller 902, cause the controller 902 to disable coupling between the second electronic device and the third electronic device.

In various examples, the machine-readable instructions, when executed by the controller 902, cause the controller 902 to determine a second context information of the electronic device 900. The second context information includes an identifier for a fourth electronic device, a location, a time, an identifier of an application executed, or a combination thereof. The machine-readable instructions, when executed by the controller 902, cause the controller 902 to determine whether a coupling profile (e.g., the coupling profiles 328, 526, 728) includes the second context information. In response to a determination that the coupling profile does not include the second context information, the machine-readable instructions, when executed by the controller 902, cause the controller 902 to generate a second coupling profile, the second coupling profile to include the second context information. The controller 902 utilizes the techniques described above with respect to FIG. 6, for example. In response to a determination that the coupling profile includes the second context information, the machine-readable instructions, when executed by the controller 902, cause the controller 902 to adjust couplings between the electronic device 900, the second electronic device, and the third electronic device based on the coupling profile.

FIG. 10 is a flow diagram of a method 1000 for an electronic device (e.g., the electronic device 102, 104, 106, 108, 110, 202, 204, 206, 208, 300, 302, 500, 700, 800, 900) having context-based couplings, in accordance with various examples. The method 1000 is a method for enabling context-based couplings and updating coupling profiles. The method 1000 includes monitoring for use of a second electronic device not included in a coupling profile used to enable current context-based couplings of a first electronic device (1002). The method 1000 also includes determining whether the context has changed (1004). In response to a determination that the context has not changed, the method 1000 additionally includes updating the coupling profile to include the second electronic device (1006). The method 1000 includes notifying a user of the update to the coupling profiles (1008). The method 1000 includes returning to monitoring for use of another electronic device not included in the coupling profile used to enable the current context-based couplings.

In response to a determination that the context has changed, the method 1000 additionally includes determining whether the changed context indicates a second coupling profile of multiple coupling profiles (1010). In response to a determination that the changed context is not included in a second coupling profile of the multiple coupling profiles, the method 1000 includes generating a new coupling profile that includes the context information and the second electronic device (1012). The method 1000 includes notifying a user of the update to the coupling profiles (1008). The method 1000 includes returning to monitoring for use of another electronic device not included in the coupling profile used to enable the current context-based couplings.

In response to a determination that the changed context is included in the second coupling profile of the multiple coupling profiles, the method 1000 includes updating the second coupling profile to include the context information (1014). The method 1000 also includes determining whether the second electronic device is in the second coupling profile (1016). In response to a determination that the second electronic device is in the second coupling profile, the method 1000 additionally includes enabling other couplings of the second coupling profile (1018). The method 1000 includes notifying a user of the update to the coupling profiles (1008). The method 1000 includes returning to monitoring for use of another electronic device not included in the coupling profile used to enable the current context-based couplings.

In response to a determination that the second electronic device is not included in the second coupling profile, the method 1000 additionally includes updating the coupling profile to include the second electronic device (1006). The method 1000 includes notifying a user of the update to the coupling profiles (1008). The method 1000 includes returning to monitoring for use of another electronic device not included in the coupling profile used to enable the current context-based couplings.

In various examples, the method 1000 includes utilizing a sensor (e.g., the sensor 308, 510, 712, 804) to monitor for use of the second electronic device. In other examples, the method 1000 transmits a signal to a host electronic device at specified intervals to determine other electronic devices in use by the host device utilizing techniques described above with respect to FIG. 6, for example. The method 1000 includes determining whether the context information has changed utilizing the techniques described above with respect to FIG. 4, for example.

Unless infeasible, some or all of the method 400, 600, 1000 may be performed by a controller (e.g., the controller 304, 312, 514, 710, 802, 902, the processor 502, 702) concurrently or in different sequences and by circuitry of an electronic device (e.g., the electronic device 102, 104, 106, 108, 110, 202, 204, 206, 208, 300, 302, 500, 700, 800, 900), execution of machine-readable instructions of the electronic device, or a combination thereof. For example, the method 400, 600, 1000 is implemented by machine-readable instructions stored to a storage device (e.g., the storage device 310, 516, 716, the non-transitory machine-readable medium 904, or another storage device not explicitly shown of the system), circuitry (some of which is not explicitly shown) of the electronic device, or a combination thereof. The controller executes the machine-readable instructions to perform some or all of the method 400, 600, 1000, for example.

In various examples, a GUI of an application (e.g., the coupling profile application 338, 530, 732) enables the user to adjust threshold values, identifying sequences, or a combination thereof, utilized while performing the method 400, 600, 1000, other techniques described above with respect to the electronic device 300, 302, 500, 700, 800, 900, or a combination thereof. For example, the user uses the GUI to adjust the threshold time, the threshold distance, or a combination thereof utilized when detecting proximity, determining measurements of a sensor (e.g., the sensor 308, 510, 712, 804), or a combination thereof. In other examples, the threshold values are set at a time of manufacture.

By utilizing the electronic device 300, 302, 500, 700, 800, 900 performing the method 400, 600, 1000, the electronic device couples to other electronic devices appropriate for a specified task based on the executing application, the location, the day, the time, the user, or other suitable context information. The user experience is improved because the user does not have to adjust the couplings manually. Resources of the electronic device 300, 302, 500, 700, 800, 900 are not unnecessarily utilized because the electronic device does not couple to other electronic devices not used for the specified task.

While some components are shown as separate components of the electronic device 300, 302, 500, 700, 800, 900 in other examples, the separate components are integrated in a single package. For example, the storage device 310, 316, 516, 716, 808, is integrated with the controller 304, 312, 514, 710, 802, respectively. The single package may herein be referred to as an integrated circuit (IC) or an integrated chip (IC).

The above description is meant to be illustrative of the principles and various examples of the present description. Numerous variations and modifications become apparent to those skilled in the art once the above description is fully appreciated. It is intended that the following claims be interpreted to embrace all such variations and modifications.

In the figures, certain features and components disclosed herein are shown in exaggerated scale or in somewhat schematic form, and some details of certain elements are not shown in the interest of clarity and conciseness. In some of the figures, in order to improve clarity and conciseness, a component or an aspect of a component are omitted.

In the above description and in the claims, the term “comprising” is used in an open-ended fashion, and thus should be interpreted to mean “including, but not limited to . . . .” Also, the term “couple” or “couples” is intended to be broad enough to encompass both direct and indirect connections. Thus, if a first device couples to a second device, that connection may be through a direct connection or through an indirect connection via other devices, components, and connections. Additionally, the word “or” is used in an inclusive manner. For example, “A or B” means any of the following: “A” alone, “B” alone, or both “A” and “B.”

What is claimed is:

1. An electronic device, comprising:
a sensor; and
a controller to:
detect a proximity of a second electronic device via the sensor;
in response to determining that the proximity is within a threshold distance, cause transmission of context information to the second electronic device, the context information is generated based on a location, a day, a time, or a combination thereof;
in response to the transmission of the context information, receive a first signal from the second electronic device; and
in response to the first signal, cause transmission of a second signal, the second signal to enable coupling to the second electronic device.

2. The electronic device of claim 1, wherein, in response to the first signal, the controller is to cause transmission of a third signal, the third signal to enable coupling to a third electronic device via the second electronic device.

3. The electronic device of claim 1, wherein the controller is to generate the context information based on an executing application, a user identifier, an identifier of a third electronic device coupled to the electronic device, or a combination thereof.

4. The electronic device of claim 3, wherein the controller is to store the context information to a coupling profile stored on a storage device of the electronic device, the coupling profile to include a second identifier of the second electronic device, the identifier of the third electronic device, the user identifier, the application executing, the location, the day, the time, or the combination thereof.

5. The electronic device of claim 1, wherein the controller is to:
detect a second proximity of a third electronic device via the sensor; and
cause transmission of a third signal to the third electronic device, the third signal to initiate an authentication protocol with the third electronic device.

6. An electronic device, comprising:
a sensor;
a communication device; and
a controller to:
detect multiple electronic devices via the sensor;
in response to determining a first electronic device of the multiple electronic devices is a host device, transmit a first signal via the communication device to the first electronic device, the first signal to request context information for the first electronic device;
receive a second signal from the first electronic device of the multiple electronic devices via the communication device, the second signal including the context information; and
based on the context information, enable coupling between the first electronic device of the multiple electronic devices and a subset of the multiple electronic devices via the communication device.

7. The electronic device of claim 6, wherein the controller is to compare the context information to coupling profiles to determine the subset of the multiple electronic devices.

8. The electronic device of claim 7, wherein the controller is to:
determine a time and an identifier of the first electronic device of the multiple electronic devices indicates a second context information;
compare the second context information to the coupling profiles to determine a second subset of the multiple electronic devices associated with the second context information; and
enable coupling between the first electronic device of the multiple electronic devices and the second subset of the multiple electronic devices.

9. The electronic device of claim 6, wherein the controller is to:
receive a third signal from the first electronic device of the multiple electronic devices via the communication device, the third signal including a second context information; and
based on the second context information, enable coupling between the first electronic device of the multiple electronic devices and a second subset of the multiple electronic devices via the communication device.

10. The electronic device of claim 9, wherein the second subset of the multiple electronic devices is different from the subset of the multiple electronic devices.

11. A non-transitory machine-readable medium storing machine-readable instructions which, when executed by a controller of an electronic device, cause the controller to:
determine a first measurement and a second measurement via a sensor, the first measurement a first distance between a second electronic device and the electronic device, and the second measurement a second distance between a third electronic device and the electronic device;
in response to the first measurement and the second measurement being less than a threshold distance, determine context information of the electronic device;
based on the context information indicating a first context, enable coupling between the electronic device to the second electronic device; and
based on the context information indicating a second context, enable coupling between the electronic device and the third electronic device.

12. The non-transitory machine-readable medium of claim 11, wherein the machine-readable instructions, when executed by the controller of the electronic device, cause the controller to:
determine a third measurement via the sensor, the third measurement a second distance between the second electronic device and the electronic device; and
in response to the third measurement being greater than the threshold distance, disable coupling between the electronic device and the second electronic device.

13. The non-transitory machine-readable medium of claim 11, wherein the machine-readable instructions, when executed by the controller of the electronic device, cause the controller to, based on the context information indicating a third context, enable coupling between the second electronic device and the third electronic device.

14. The non-transitory machine-readable medium of claim 13, wherein the machine-readable instructions, when executed by the controller of the electronic device, cause the controller to:
determine a third measurement and a fourth measurement via the sensor, the third measurement a second distance between the second electronic device and the electronic device, and the fourth measurement a second distance between the third electronic device and the electronic device; and
in response to the third measurement or the fourth measurement being greater than the threshold distance, disable coupling between the second electronic device and the third electronic device.

15. The non-transitory machine-readable medium of claim 11, wherein the machine-readable instructions, when executed by the controller of the electronic device, cause the controller to:
determine a second context information of the electronic device, the second context information to include a first identifier for a fourth electronic device, a location, a time, a second identifier of an application executed, or a combination thereof;
determine whether a coupling profile includes the second context information;
in response to a determination that the coupling profile does not include the second context information, generate a second coupling profile, the second coupling profile to include the second context information; and
in response to a determination that the coupling profile includes the second context information, adjust couplings between the electronic device, the second electronic device, and the third electronic device based on the coupling profile.
